(19) United States
(12) Patent Application Publication
(10) Pub. No.: US 2011/0284490 A1
(43) Pub. Date: Nov. 24, 2011

(54) CRANE BOOM WITH MULTI MAIN-CHORD

(75) Inventors: Jinjiang LIU, Shanghai (CN); Mingqi LI, Shanghai (CN); Jianguo LIAO, Shanghai (CN); Yuquan LIU, Shanghai (CN); Guowei YU, Shanghai (CN); Zhengmao SUN, Shanghai (CN)

(73) Assignee: SHANGHAI SANY TECHNOLOGY CO., LTD., Shanghai (CN)

(21) Appl. No.: 12/893,787

(22) Filed: Sep. 29, 2010

(30) Foreign Application Priority Data
May 21, 2010 (CN) 201010181662.5

(51) Int. Cl. B66C 23/64

(52) U.S. Cl. 212/347

(57) ABSTRACT

The present invention provides a crane boom with multi main chord consisting of an underpart boom sections, an insert jib section and a boom head connected in turn. Said underpart boom sections and insert jib section are multi-main-chord boom sections, there is a main-chord on each of the angle part of the cross-section of the multi-main-chord boom section. Said main-chords are connected one another by several belly bars. Add at least one main-chord on the angle part of the cross section along the width or the height of said multi-main-chord boom, and the added main-chord parallels to the original main-chord. The crane boom with multi main chord of the present invention, without changing the size of the boom sections during transporting, the cross-sectional area of the main-chord is increased and the integral stiffness of the boom is strengthened by increasing main-chord number of boom, thus fold increasing the structural carrying capacity of the boom which is suitable for large crane.

### TECHNICAL FIELD

The present invention refers to a crane boom, and it particularly refers to a crane boom with multi main chord.

### BACKGROUND

The current truss boom of a crane generally composes of multiple boom sections. The boom sections are generally polygon, such as rectangular etc. And there is a main chord set on each corner around the cross-section of the boom sections. The disadvantage of the boom is that the requirements of the size during transporting shall restrict the width and height of the cross-section of the boom sections. Therefore there is corresponding ultimate structural carrying capacity for the above mentioned boom system, and it further limits the scope of application.

U.S. Pat. No. 7,516,858 by Hans-Dieter Willim describes a crane boom, comprising a boom guying which has at least one guy rope which is guided from an inner articulation point in the region of a boom articulation point to an outer articulation point in the region of a projecting boom part. The guy rope is articulated at its outer end such that the guy rope force induces a bending moment in the crane boom which counters the sagging of the crane boom. The outer articulation point of the guy rope is arranged spaced apart from the boom part at an articulation jib which is secured to the boom part such that a tensile force of the guy rope induces a bending moment into the crane boom via the articulation jib, said bending moment reducing the bending moment generated in the boom by a hook load and the boom's own weight. The articulation jib which projects transversely to the longitudinal boom axis forms a bending moment jib, so to say, which is secured to the outer end of the crane boom or to one of the outer boom parts such that a bending moment reducing the sagging of the crane boom is generated in the crane boom by the guying force via the articulation jib.

US Patent Publication No. 2009/0139948 A1 by Nathan P. Holly, Robert J. Walker and Feng Pan describes a crane has a boom with a boom segment connection system. The boom includes at least a first and second boom segment each with a longitudinal axis and a first and second end, the second end of the first segment being coupled to the first end of the second segment, and at least one first connector on the second end of the first segment respectively mating with at least one second connector on the first end of the second segment. The first and second connectors each include at least one extension having an aperture there through. The aperture has an axis perpendicular to the longitudinal axis and positioned in the extensions such that all apertures of mating first and second connectors are aligned when the boom segments are aligned.

U.S. Pat. No. 7,565,982 by Hitoshi Kurotsu, Osamu Todo and Kaziyuki Miyazaki describes a boom hoisting device comprising a mast having a pivotable front end portion connected to a front end portion of a boom through a guy line, a mast-side spreader provided at the front end portion of the mast, a frame-side spreader removably mounted to an upper rotating body and with a hoisting rope being stretched between and spread on both mast-side spreader and frame-side spreader, and a hoisting winch adapted to unwind and wind the hoisting rope to raise and lower the mast and the boom, the hoisting winch being mounted to the mast so that the mast and the hoisting winch are together removed from the upper rotating body by separation of a base end portion of the mast from the upper rotating body.

### SUMMARY OF THE INVENTION

The purpose of the present invention is to provide a crane boom with multi main chord. Without changing the size of the boom sections during transporting, the cross-sectional area of the main chord is increased and the integral stiffness of the boom is strengthened by increasing the number of the main chord of the boom. Thus the structural carrying capacity of the boom is improved.

To achieve this purpose, the technical solutions of the present invention are as follows: A crane boom with multi main chord, comprising an underpart boom section, an insert jib section and a boom head connected in turn; wherein, the said underpart boom section and insert jib section are multi-main-chord boom section, there is a main-chord on every corner of the cross-section of the multi-main-chord boom section; the said main-chords are connected one another by several belly bars; in the horizontal or longitudinal direction, at least one main-chord on every corner of the cross-section of the said multi-main-chord boom are added, and the added main-chord parallels to the original main-chord.

The crane boom with multi main chord mentioned above, wherein, the added main-chord on every corner of the cross-section of the said multi-main-chord boom and the adjacent original main-chord are interconnected by belly bars, web plates or directly welding, in order to form space truss structure.

The crane boom with multi main chord mentioned above, wherein, the added main-chord on every corner of the cross-section of the multi-main-chord boom is set closely enough to the original main-chord.

The crane boom with multi main chord mentioned above, wherein, in the horizontal and longitudinal direction, at least one main-chord on every corner of the cross-section of the said multi-main-chord boom are added respectively, and the added main-chords parallels to the original main-chord.

A multi-main-chord boom section for constituting the crane boom, there is a main-chord on every corner of the cross-section of the boom section, the said main-chords are connected by several belly bars, wherein, in the horizontal or longitudinal direction, at least one main-chord on every corner of the cross-section of the said boom section are added, and the added main-chords parallels to the original main-chord.

The multi-main-chord boom section for constituting the crane boom mentioned above, wherein, the added main-chord on every corner of the cross-section of the boom section and the adjacent original main-chord are connected by belly bars, web plates or directly welding, in order to form space truss structure.

The multi-main-chord boom section for constituting the crane boom mentioned above, wherein, the added main-chord on every corner of the cross-section of the boom section is set closely enough to the original main-chord.

The multi-main-chord boom section for constituting the crane boom mentioned above, wherein, in the horizontal and longitudinal direction, at least one main-chord on every corner of the cross-section of the multi-main-chord boom section are added respectively and the added main-chords parallels to the original main-chord.

The advantages of the present invention are as follows:

1. Without changing the size of the boom sections during transporting, the cross-sectional area of the main-chord is increased and the integral stiffness of the boom is strengthened by increasing the number of the main-chord of the boom, thus the structural carrying capacity of the boom is improved which is very suitable for large crane.

2. Without changing the size of the boom sections during transporting, the crane boom with multi main chord composed of the multi-main-chord boom section has greater structure carrying capacity than the conventional boom composed of truss booms.

### BRIEF DESCRIPTION OF THE DRAWING

FIG. 1 is a front view of the crane boom with multi main chord, according to the first preferred embodiment of the present invention;

FIG. 2 is a top view of the crane boom with multi main chord, according to the first preferred embodiment of the present invention;

FIG. 3 is a cubic diagram of the insert jib section of the crane boom with multi main chord, according to the first preferred embodiment of the present invention;

FIG. 4 is a front view of the insert jib section of crane boom with multi main chord, according to the first preferred embodiment of the present invention;

FIG. 5 is a sectional view of the insert jib section of the crane boom with multi main chord, according to the first preferred embodiment of the present invention, taken along line A-A;

FIG. 6 is a front view of the crane boom with multi main chord, according to the second preferred embodiment of the present invention;

FIG. 7 is a top view of the crane boom with multi main chord, according to the second preferred embodiment of the present invention;

FIG. 8 is a cubic diagram of the insert jib section of the crane boom with multi main chord, according to the second preferred embodiment of the present invention;

FIG. 9 is a top view of the insert jib section of the crane boom with multi main chord, according to the second preferred embodiment of the present invention;

FIG. 10 is a sectional view of the insert jib section of the crane boom with multi main chord, according to the second preferred embodiment of the present invention, taken along line B-B;

FIG. 11 is a front view of the crane boom with multi main chord, according to the third preferred embodiment of the present invention;

FIG. 12 is a top view of the crane boom with multi main chord, according to the third preferred embodiment of the present invention;

FIG. 13 is a cubic diagram of the insert jib section of the crane boom with multi main chord, according to the third preferred embodiment of the present invention;

FIG. 14 is a front I view of the insert jib section of the crane boom with multi main chord, according to the third preferred embodiment of the present invention;

FIG. 15 is a sectional view of the insert jib section of the crane boom with multi main chord according to the third preferred embodiment of the present invention, taken along line A-A;

FIG. 16 is a front view of the crane boom with multi main chord, according to the forth preferred embodiment of the present invention;

FIG. 17 is a top view of the crane boom with multi main chord, according to the forth preferred embodiment of the present invention;

FIG. 18 is a cubic diagram view of the insert jib section of the crane boom with multi main chord, according to the forth preferred embodiment of the present invention;

FIG. 19 is a top view of the insert jib section of the crane boom with multi main chord, according to the forth preferred embodiment of the present invention;

FIG. 20 is a sectional view of the insert jib section of the crane boom with multi main chord depicted in the forth preferred embodiment of the present invention, taken along line B-B;

FIG. 21 is a front view of the crane boom with multi main chord, according to the fifth preferred embodiment of the present invention;

FIG. 22 is a top view of the crane boom with multi main chord, according to the fifth preferred embodiment of the present invention;

FIG. 23 is a cubic diagram of the insert jib section of the crane boom with multi main chord, according to the fifth preferred embodiment of the present invention;

FIG. 24 is a front view of the insert jib section of the crane boom with multi main chord, according to the fifth preferred embodiment of the present invention;

FIG. 25 is a sectional view of the insert jib section of the crane boom with multi main chord depicted in the fifth preferred embodiment of the present invention, taken along line A-A;

FIG. 26 is a front view of the crane boom with multi main chord, according to the sixth preferred embodiment of the present invention;

FIG. 27 is a top view of the crane boom with multi main chord, according to the sixth preferred embodiment of the present invention;

FIG. 28 is a cubic diagram of the insert jib section of the crane boom with multi main chord, according to the sixth preferred embodiment of the present invention;

FIG. 29 is a top view of the insert jib section of the crane boom with multi main chord, according to the sixth preferred embodiment of the present invention;

FIG. 30 is a sectional view of the insert jib section of the crane boom with multi main chord according to the sixth preferred embodiment of the present invention, taken along line B-B.

### DETAILED DESCRIPTION OF THE INVENTION

The invention will now be described in more details as follows combining the drawings and the embodiments.

Embodiment 1:

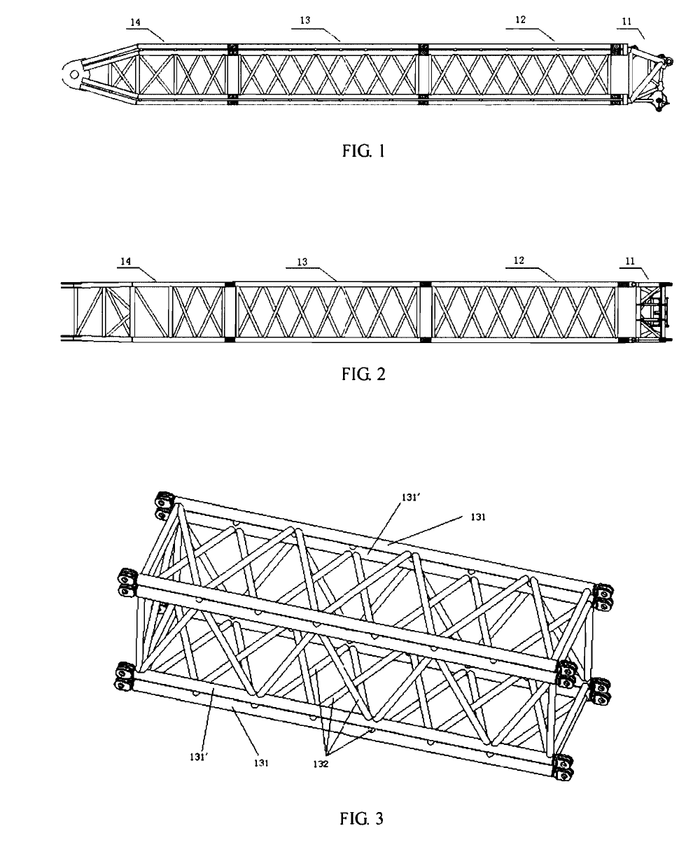

Refer to FIG. 1 and FIG. 2, the crane boom with multi main chord of the present invention, it is composed of an underpart boom section 14, insert jib sections 12 and 13 and a boom head 11 connected in turn.

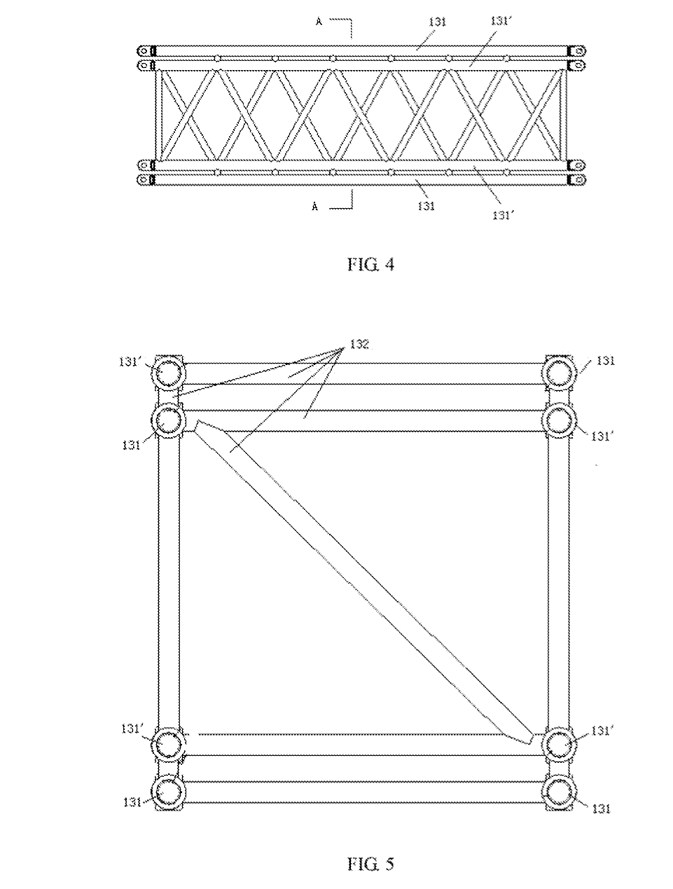

In this embodiment, insert jib sections 12, 13 and underpart boom section 14 are multi-main-chord structures, and the cross-section is rectangular. As shown in FIG. 3-FIG. 5, taking insert jib section 13 for example, it has four main-chords 131, and there is an additional main-chord 131′ in the longitudinal direction of every of the main-chords 131, thus forming a eight-main-chord structure; two main-chord 131, 131′ are connected by several belly bars 132, forming a boom with rectangular cross-section in order to form a space structural system.

Embodiment 2:

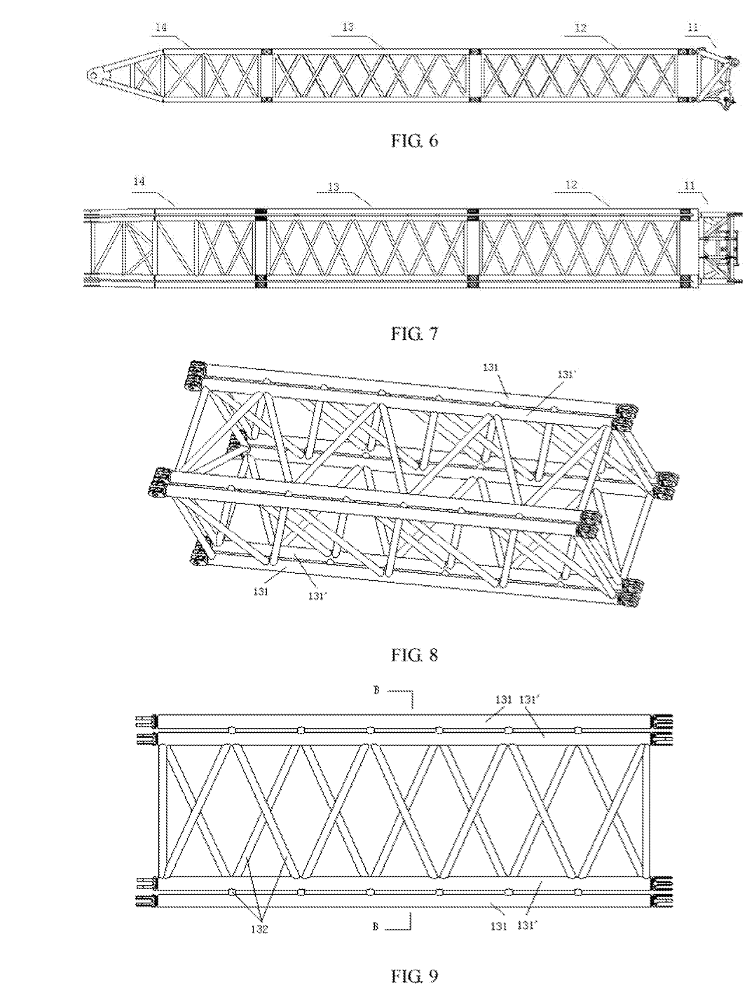

Refer to FIG. 6-FIG. 10, it is another embodiment of the present invention. The structure of the crane boom with multi main chord in this embodiment is similar to that in embodiment 1. The differences between them are in that: the insert jib section 13 of the crane boom with multi main chord in this embodiment (taking the insert jib section 13 for example) has a rectangular cross-section and has four main-chords 131, and there is an additional main-chord 131′ in the horizontal direction of each of the main-chords 131, thus forming a eight-main-chord structure. Every other main-chord is connected by several belly bars 132 forming a boom with rectangular cross-section in order to form a space structural system.

Embodiment 3:

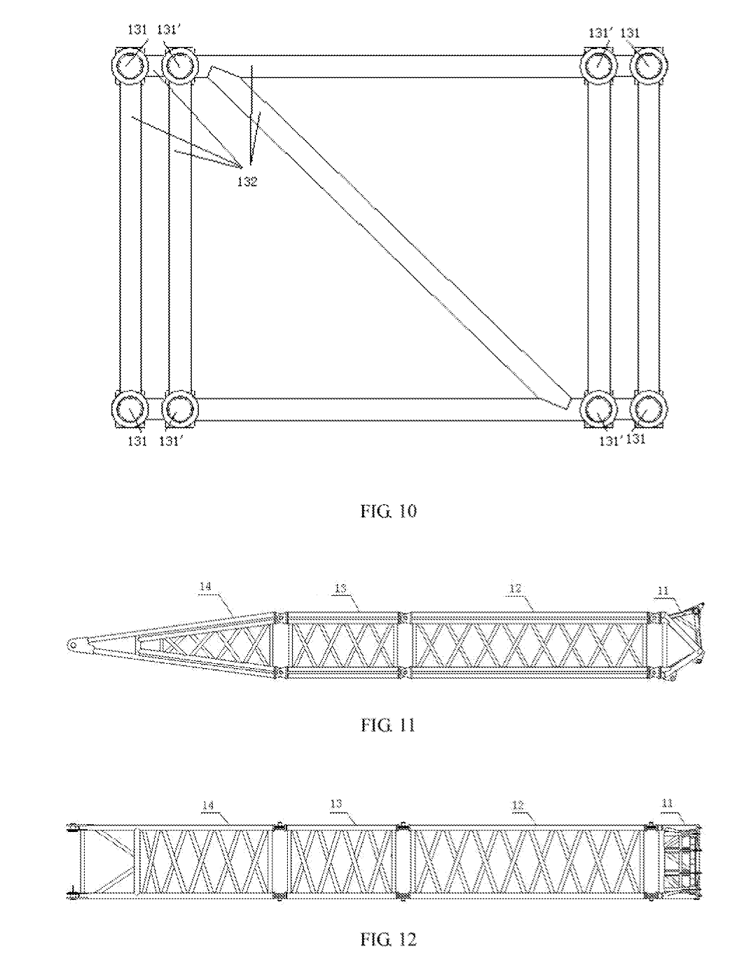

According to FIG. 11 and FIG. 12, the crane boom with multi main chord of the present invention, it is composed of an underpart boom section 14, insert jib sections 12 and 13 and a boom head 11 connected in turn.

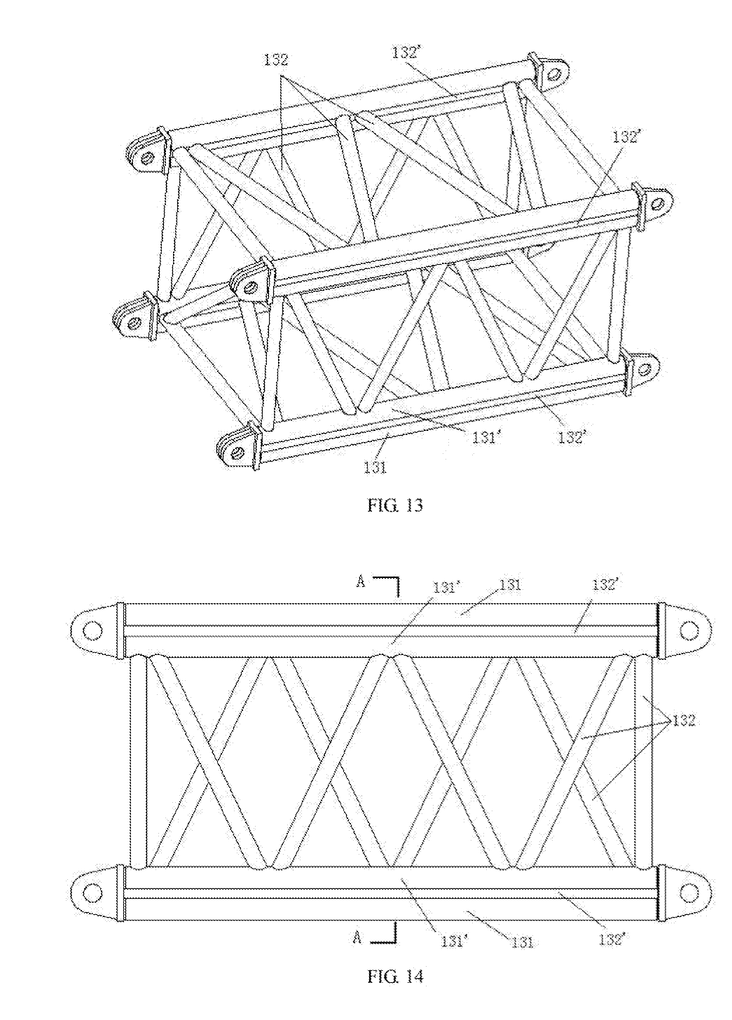

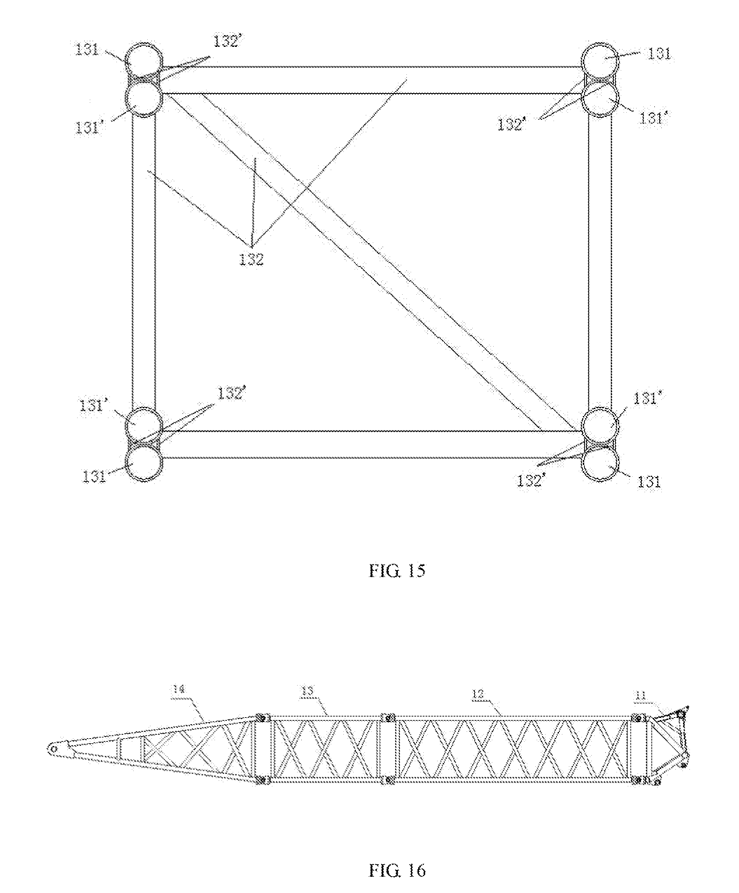

In this embodiment, insert jib sections 12, 13 and underpart boom section 14 are multi-main-chord structures, and the cross-sections are rectangular. As shown in FIG. 13-FIG. 15, taking the insert jib section 13 for example, it has four main-chords 131, and there is an additional main-chord 131′ in the longitudinal direction of the main-chords 131, thus forming a eight-main-chord structure; the main-chords 131, 131′belonging to different angle part are connected by belly bar 132, the main-chords 131, 131′belonging to the same angle part are connected by web plate 132′, forming a boom with rectangular cross-section in order to form a space structural system.

Embodiment 4:

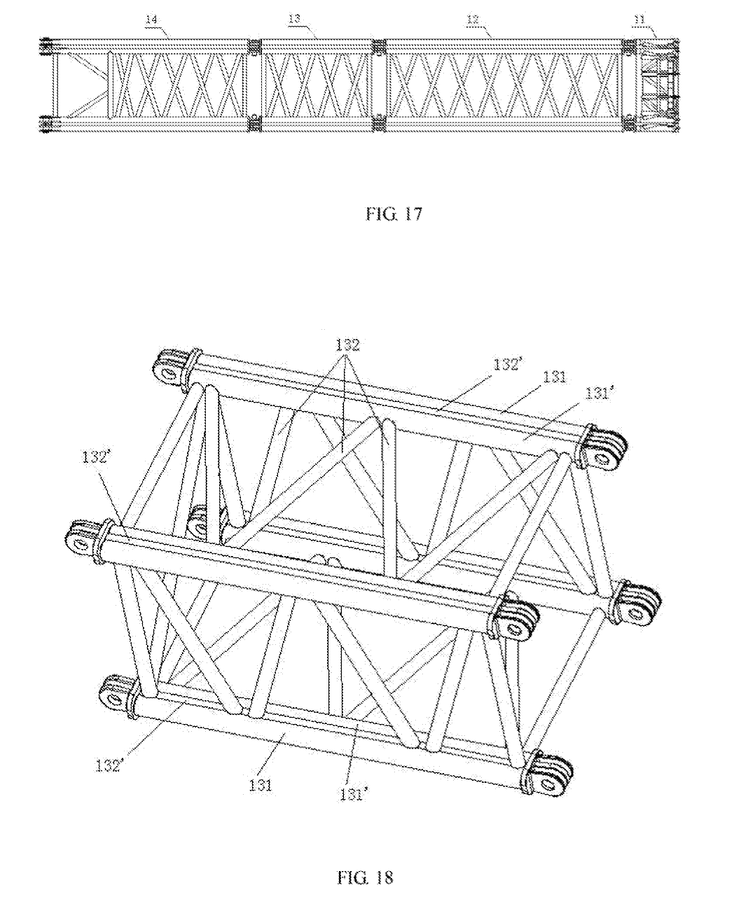

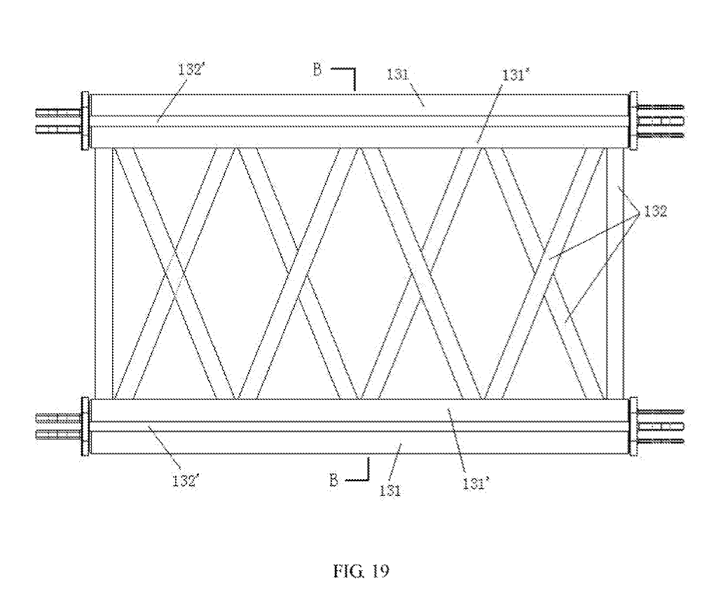

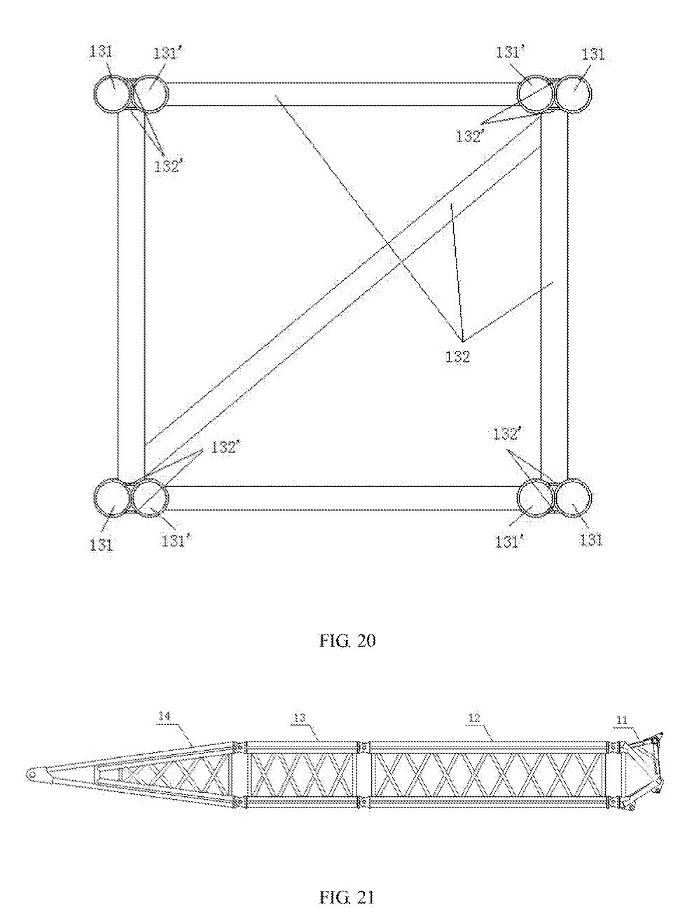

Refer to FIG. 16-FIG. 20, it is another embodiment of the present invention. The structure of the crane boom with multi main chord in this embodiment is similar to that in embodiment 3. The differences between them are in that: the insert jib section 13 of the crane boom with multi main chord in this embodiment (taking insert jib section 13 for example) has a rectangular cross-section and have four main-chords 131, and there is an additional main-chord 131′ in the horizontal direction of each of the main-chords 131. The main-chords 131, 131′ belonging to different angle parts are connected by belly bar 132, the main-chords 131, 131′ belonging to the same angle part are connected by web plate 132′, forming a boom with rectangular cross-section in order to form a space structural system.

Embodiment 5:

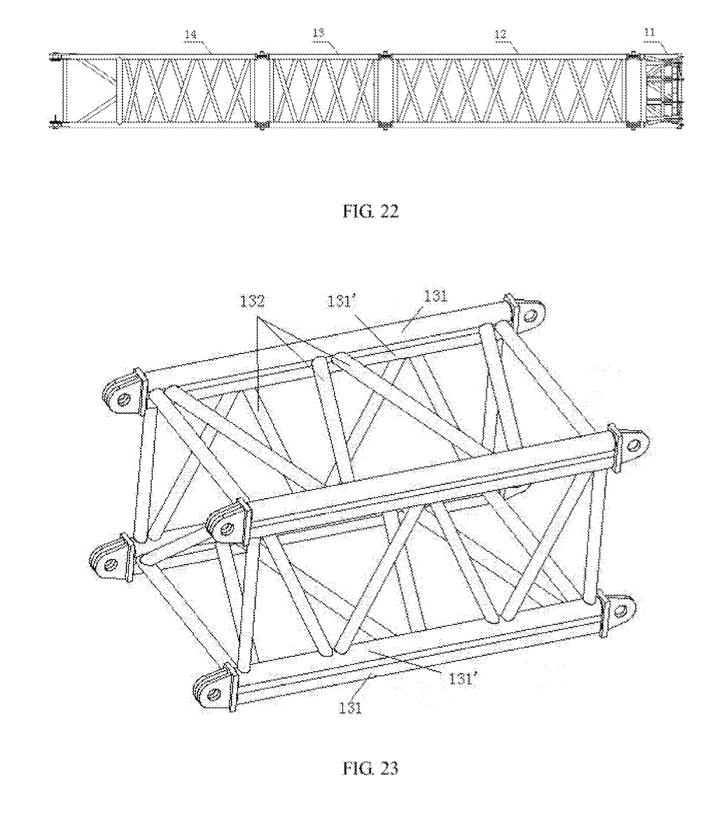

Refer to FIG. 21 and FIG. 22, the crane boom with multi main chord of the present invention, it is composed of an underpart boom section 14, insert jib sections 12 and 13 and a boom head 11 connected in turn.

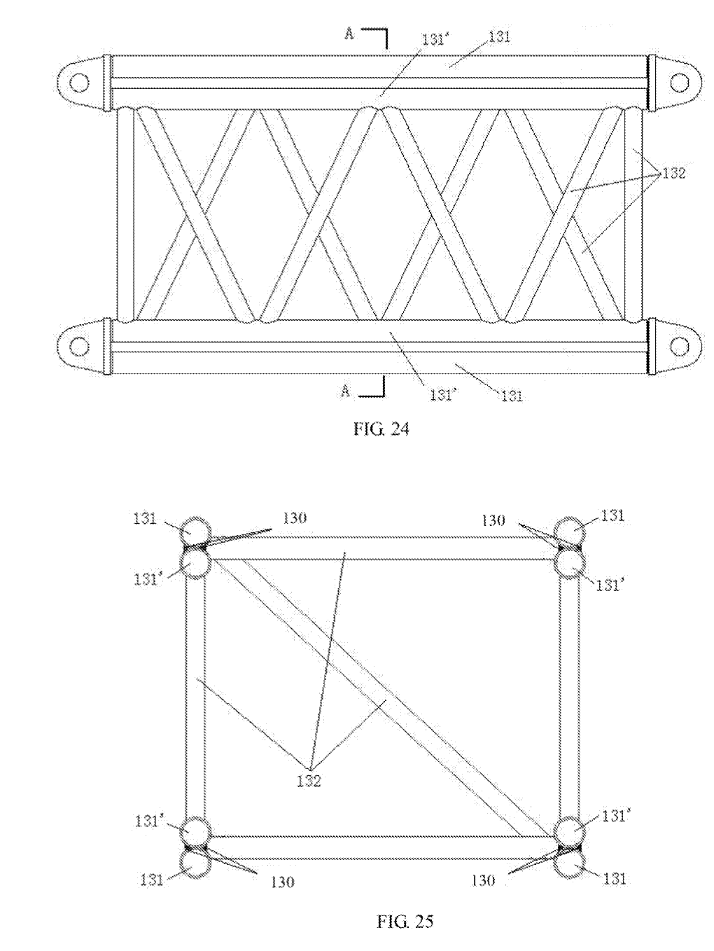

In this embodiment, insert jib sections 12, 13 and underpart boom section 14 are multi-main-chord structures, and the cross-sections are rectangular. As shown in FIG. 23-FIG. 25, taking the insert jib section 13 for example, it has four main-chords 131, and there is an additional main-chord 131′ in the longitudinal direction of each of the main-chords 131, thus forming a eight-main-chord structure; The main-chords 131, 131′ belonging to different angle part are connected by belly bar 132, the main-chords 131, 131′ belonging to the same angle part are connected by welding, forming a boom with rectangular cross-section in order to form a space structural system. A welding seam 130 is formed between main-chords 131 and 131′.

Embodiment 6:

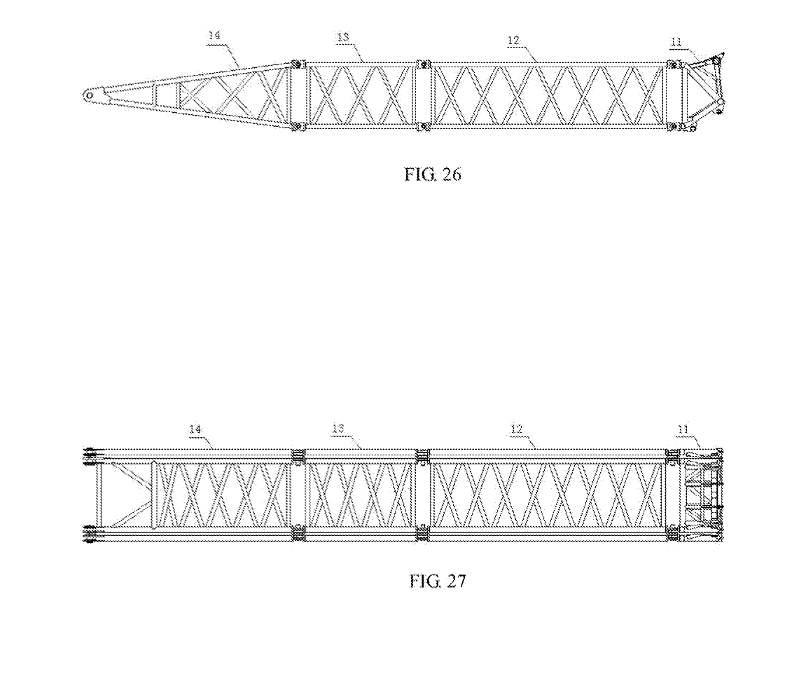

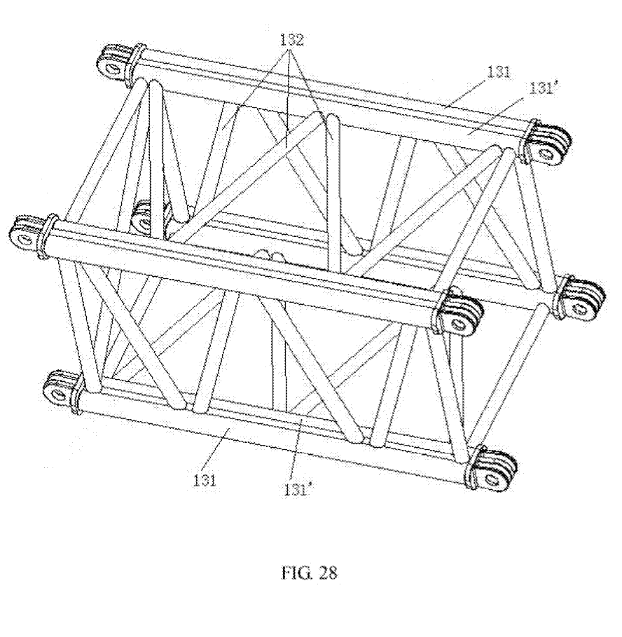

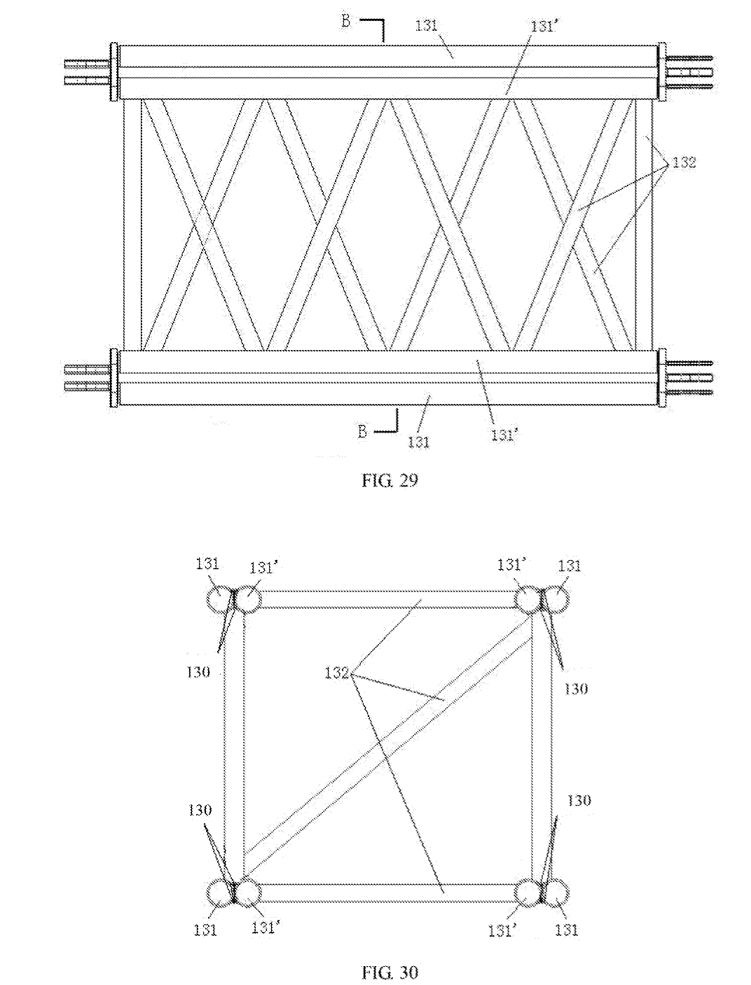

Refer to FIG. 26-FIG. 30, it is another embodiment of the present invention. The structure of the crane boom with multi main chord in this embodiment is similar to that in embodiment 5.

The differences between them are in that: the insert jib section 13 of the crane boom with multi main chord in this embodiment (taking the insert jib section 13 for example) has a rectangular cross-section and have four main-chords 131, and there is an additional main-chord 131′ in the horizontal direction of each of the main-chords 131. The main-chords 131, 131′belonging to different angle parts are connected by belly bar 132, the main-chords 131, 131′belonging to the same angle part are connected by welding, forming a boom with rectangular cross-section in order to form a space structural system. A welding seam 130 is formed between main-chords 131 and 131′.

Insert jib sections 12, 13 and underpart boom section 14 of the present invention are connected in turn to form a multi-main-chord boom, it has greater structure carrying capacity than the conventional truss boom composed of four main-chords with rectangular cross-section.

The boom having eight main-chords depicted in above six embodiments, its cross-sectional area is two times of that of the boom having four main-chords; and, the shorter the distance between two main-chords in each main-chord group, the greater the integral stiffness and resisting moment of the boom; when the distance between two main-chords in each main-chord group is short enough, the integral stiffness and resisting moment of the eight-main-chord boom are two times of that of the four-main-chords boom. Therefore, the working conditions of short boom or long boom can get two times of carrying capacity. Therefore, the additional main-chord on each of the angle part of the cross-section of the crane boom with multi main chord is set closely enough to the original main-chord. As to the skilled in the art, two main-chords are set in a minimum distance close to each other to get better carrying capacity.

In a word, in the present invention, without changing the size of the boom sections during transporting, cross-sectional area of the main-chord is increased and the integral stiffness of the boom is strengthened by increasing the number of the main-chord of the boom, thus the structure carrying capacity of the boom is improved which is very suitable for large crane.

It is the detailed description of the specific embodiment of this invention above, but the invention is not limited to the specific embodiments, which are just as examples. To the skilled in the art, the equivalent changes and substitutions made to the main chord also fall into the scope of this invention. Therefore, the equivalent transformation and modification which are not depart from the spirit and scope of this invention should be within the scope of this invention.

1. A crane boom with multi main chord, comprising an underpart boom section, an insert jib section and a boom head connected in turn; characterized in that, the said underpart boom section and insert jib section are multi-main-chord boom section, there is a main-chord on every corner of the cross-section of the multi-main-chord boom section; the said main-chords are connected one another by several belly bars; in the horizontal or longitudinal direction, at least one main-chord on every corner of the cross-section of the said multi-main-chord boom are added, and the added main-chord parallels to the original main-chord.

2. The crane boom with multi main chord according to claim 1, wherein, the added main-chord on every corner of the cross-section of the said multi-main-chord boom and the adjacent original main-chord are interconnected by belly bars, web plates or directly welding, in order to form space truss structure.

3. The crane boom with multi main chord according to claim 1, wherein, the added main-chord on every corner of the cross-section of the multi-main-chord boom is set closely enough to the original main-chord.

4. The crane boom with multi main chord according to claim 1, wherein, in the horizontal and longitudinal direction, at least one main-chord on every corner of the cross-section of the said multi-main-chord boom are added respectively, and the added main-chords parallels to the original main-chord.

5. A multi-main-chord boom section for constituting the crane boom, there is a main-chord on every corner of the cross-section of the boom section, the said main-chords are connected by several belly bars, characterized in tha, in the horizontal or longitudinal direction, at least one main-chord on every corner of the cross-section of the said boom section are added, and the added main-chords parallels to the original main-chord.

6. The multi-main-chord boom section for constituting the crane boom according to claim 5, wherein, the added main-chord on every corner of the cross-section of the boom section and the adjacent original main-chord are connected by belly bars, web plates or directly welding, in order to form space truss structure.

7. The multi-main-chord boom section for constituting the crane boom according to claim 5, wherein, the added main-chord on every corner of the cross-section of the boom section is set closely enough to the original main-chord.

8. The multi-main-chord boom section for constituting the crane boom according to claim 5, wherein, in the horizontal and longitudinal direction, at least one main-chord on every corner of the cross-section of the multi-main-chord boom section are added respectively and the added main-chords parallels to the original main-chord.
